(19) United States
(12) Patent Application Publication
(10) Pub. No.: US 2008/0158777 A1
(43) Pub. Date: Jul. 3, 2008

(54) Capacitor and multi-layer board embedding the capacitor

(75) Inventors: Seung Hyun Sohn, Suwon (KR); Yul Kyo Chung, Yongin (KR); Seung Eun Lee, Sungnam (KR); Yee Na Shin, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 11/979,770

(22) Filed: Nov. 8, 2007

(30) Foreign Application Priority Data
Dec. 29, 2006 (KR) 10-2006-0137583

(51) Int. Cl. H01G 4/06; H01G 4/00

(52) U.S. Cl. 361/321.1; 361/301.1

(57) ABSTRACT

There are provided a capacitor and a thin film capacitor-embedded multi-layer wiring board. The capacitor includes: first and second electrodes connected to first and second polarities; a dielectric layer formed therebetween; and at least one floating electrode disposed inside the dielectric layer and having overlaps with the first and second electrodes. The wiring board includes: an insulating body having a plurality of insulating layers thereon; a plurality of conductive patterns and conductive vias formed on the insulating layers, respectively, to constitute an interlayer circuit; and a thin film capacitor embedded in the insulating body, wherein the thin film capacitor includes a first electrode layer, a first dielectric layer, at least one floating electrode layer, a second dielectric layer and a second electrode layer sequentially formed, and wherein the first and second electrode layers are connected to the interlayer circuit and the floating electrode layer is not directly connected thereto.

### CROSS-REFERENCE TO RELATED APPLICATIONS

This application claims the priority of Korean Patent Application No. 2006-137583 filed on Dec. 29, 2006, in the Korean Intellectual Property Office, the disclosure of which is incorporated herein by reference.

### BACKGROUND OF THE INVENTION

1. Field of the Invention

The present invention relates to a novel capacitor, and more particularly, to a high-capacitance capacitor capable of preventing capacitor characteristics from deteriorating due to leakage current, and a multi-layer board embedding the capacitor.

2. Description of the Related Art

A general capacitor features a metal-insulator-metal (MIM) structure. In the capacitor, capacitance C is proportional to an area A thereof and inversely proportional to a thickness d of a dielectric material according to following equation.

$$C = {ɛ}_{0} {ɛ}_{r} \frac{A}{d}$$

where ε₀ is a dielectric constant in a vacuum state and εᵣ is a dielectric constant of the dielectric material.

As noted in the equation above, the dielectric material having a high dielectric constant and a smaller thickness ensures high-capacitance of the capacitor. That is, a ferroelectric layer with a small thickness is beneficial for manufacturing a high-capacitance capacitor. Furthermore, this leads to thinness of the capacitor, thereby miniaturizing the product.

With the embedded passive device technology gathering attention lately, the thinner capacitor assuring high-capacitance will be advantageously applied to manufacture slimmer electronic products.

However, a smaller thickness of the dielectric layer is often accompanied by loss and degradation in characteristics such as leakage current depending on the material thereof. Therefore, it would not be desirable to reduce a thickness of the dielectric layer beyond a certain level to increase capacitance.

Alternatively, in various capacitor-embedded multi-layer wiring boards, the capacitor may be increased in its area or an additional capacitor may be embedded to obtain higher capacitance. However, this also complicates the designing of an interlayer circuit.

As a result, there has been a demand in the art for a novel capacitor which is not degraded in capacitor characteristics caused by increase in loss due to leakage current and does not require additional designing of a complicated interlayer circuit even when embedded in a multi-layer wiring board.

### SUMMARY OF THE INVENTION

An aspect of the present invention provides a novel capacitor capable of ensuring higher capacitance in a similar effect obtained from reducing a thickness of a dielectric layer, without a significant increase in its thickness.

An aspect of the present invention also provides a multiplayer board embedding the capacitor capable of ensuring high capacitance, while being minimized in capacitor-induced increase in thickness.

According to an aspect of the present invention, there is provided a capacitor including: first and second electrodes connected to first and second polarities, respectively; a dielectric layer formed between the first and second electrodes; and at least one floating electrode having overlaps with the first and second electrodes to form a capacitance in each of the overlaps, the floating electrode disposed inside the dielectric layer.

The floating electrode may be disposed in parallel with the first and second electrodes.

The floating electrode may be a plurality of floating electrode layers disposed coplanarly and spaced apart from one another.

The floating electrode may be spaced apart from the first electrode and the second electrode at a substantially identical distance, respectively.

According to another aspect of the present invention, there is provided a capacitor-embedded multi-layer wiring board including: an insulating body having a plurality of insulating layers deposited thereon; a plurality of conductive patterns and conductive vias formed on the insulating layers, respectively to constitute an interlayer circuit of the insulating body; and a thin film capacitor embedded in the insulating body, wherein the thin film capacitor comprises a first electrode layer, a first dielectric layer, at least one floating electrode layer, a second dielectric layer and a second electrode layer sequentially formed, and wherein the first and second electrode layers are connected to the interlayer circuit and the floating electrode layer is not directly connected to the interlayer circuit and has overlaps with the first and second electrode layers to form a capacitance in each of the overlaps.

The insulating layer may be a fired ceramic layer and the multi-layer wiring board may be a multi-layer ceramic board.

The insulating layer may contain polymer and the multi-layer wiring board may be a printed circuit board.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a capacitor according to an exemplary embodiment of the invention;

FIGS. 2A and 2B illustrate a floating electrode applicable to a capacitor according to an exemplary embodiment of the invention;

FIG. 3 is a cross-sectional view illustrating a capacitor-embedded low temperature co-fired ceramic (LTCC) board according to an exemplary embodiment of the invention;

FIG. 4 is a cross-sectional view illustrating a capacitor-embedded printed circuit board according to an exemplary embodiment of the invention; and

FIGS. 5A and 5B are graphs illustrating characteristics of thin film capacitors manufactured according to Inventive Example and Comparative Example, respectively.

### DETAILED DESCRIPTION OF THE PREFERRED EMBODIMENT

Exemplary embodiments of the present invention will now be described in detail with reference to the accompanying drawings.

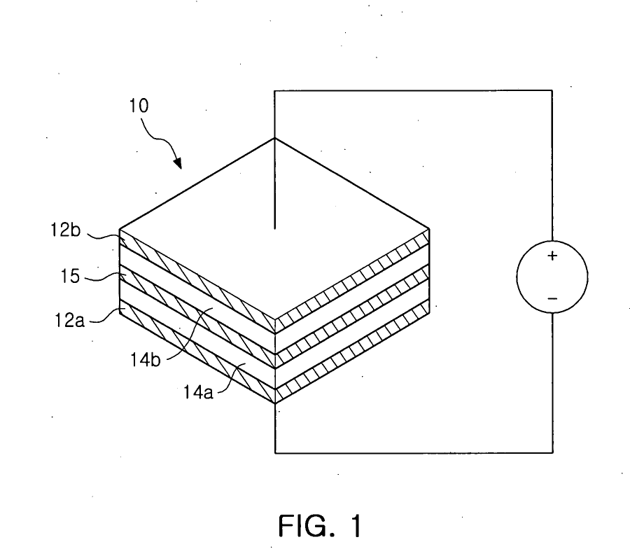

FIG. 1 is a schematic perspective view illustrating a capacitor according to an exemplary embodiment of the invention.

Referring to FIG. 1, the capacitor 10 includes first and second electrodes 12a and 12b, a dielectric layer 14 interposed between the first and second electrodes 12a and 12b, and a floating electrode 15 disposed inside the dielectric layer 14.

In the capacitor configured as above, the dielectric layer 14 is construed to be divided into first and second dielectric layers 14a and 14b by the floating electrode 15 disposed to overlap with the first and second electrodes 12a and 12b.

In the capacitor 10 shown in FIG. 1, the first and second electrodes 12a and 12b are connected to first and second polarities of a certain supply voltage, respectively. The floating electrode 15 is not directly connected to the supply voltage and interposed between the first and second dielectric layer 14a and 14b not to come in direct contact with the first and second electrodes 12a and 12b.

The capacitor 10 employing the floating electrode 15 may be considerably increased in capacitance over a general metal-insulator-metal (MIM) capacitor having a dielectric layer with a thickness equal to a total thickness of the first and second dielectric layers 14a and 14b. The capacitor 10 has capacitance generated from the first and second electrode layers 12a and 12b connected to the supply voltage and the first and second dielectric layers 14a and 14b disposed therebetween. Also, the capacitor 10 has an additional capacitance element generated. More specifically, in the capacitor 10, even though the floating electrode 15 is not directly connected to the supply voltage, the floating electrode 15—the first dielectric layer 14a—the first electrode 12a, and the floating electrode 15—the second dielectric layer 14b—the second electrode 12b form an additional pseudo capacitance element, respectively. Here, the pseudo capacitance elements are construed to be connected in series with each other by the floating electrode 15. Moreover, the pseudo capacitance elements connected in series form an equivalent circuit connected in parallel with an existing capacitance element, i.e., a capacitance of the capacitor having the first and second electrodes 12a and 12b, and the dielectric layers 14a and 14b interposed therebetween, respectively. Therefore, as described above, the floating electrode 15 provides the additional capacitance together with the existing capacitance, thereby leading to higher capacitance.

The capacitor 10 structured according to the present embodiment assures higher capacitance than the conventional capacitor which has a dielectric layer with an identical thickness to that of the capacitor of the present embodiment. Also, the capacitor 10 offers a variety of advantages. Experimental results of the inventors have found that the floating electrode 15 serves to reduce loss caused by leakage current. This will be described in detail by way of examples which will follow.

As described above, the capacitor of the present embodiment solves the loss problem involving thinning of the dielectric layers 14a and 14b to obtain high capacitance. Furthermore, the capacitor ensures higher capacitance even though the dielectric layer thereof has a thickness identical to that of the conventional capacitor, thereby beneficially utilized in a wide range of capacitor applications.

As shown in FIG. 1, the floating electrode 15 is disposed inside the dielectric layer 14 but in parallel with the first and second electrodes 12a and 12b, respectively. This allows easier designing of a capacitor with desired capacitance, simplifies a manufacturing process of the capacitor and enables reproducibility of the process, thereby solving problems associated with dispersion.

Particularly, the floating electrode 15 is spaced apart from the first and second electrodes 12a and 12b at a substantially identical distance, respectively, to realize higher capacitance when the first and second dielectric layers 14a and 14b are identical in thickness. That is, according to the present embodiment, the first dielectric layer 14a may be identical in thickness with the second dielectric layer 14b to attain higher capacitance.

As described above, the pseudo capacitance element defined by the floating electrode 15—the first dielectric layer 14a—the first electrode 12a and the pseudo capacitance element defined by the floating electrode 15—the second dielectric layer 14b—the second electrode 12b are connected in series with each other. The serially connected pseudo capacitance elements are connected in parallel with the existing capacitance to constitute an equivalent circuit. In this serial connection of the capacitor, the capacitor has the highest capacitance when two capacitance elements are substantially identical. Therefore the first and second dielectric layers 14a and 14b may be identical in thickness. Meanwhile, when one of the first and second dielectric layers has a thickness smaller than a critical thickness, i.e., the thickness considering yield, shortage and leakage current, the capacitor may undergo defects in characteristics.

As described above, according to the present embodiment, the floating electrode is disposed inside the dielectric layer and not connected to the supply voltage, thereby enhancing capacitance and dielectric characteristics. Also, the present embodiment may be carried out in various modifications. Especially, the floating electrode is interposed between the first and second dielectric layers and has overlaps with the first and second electrodes to form a capacitance in each of the overlaps. However this arrangement may be modified variously.

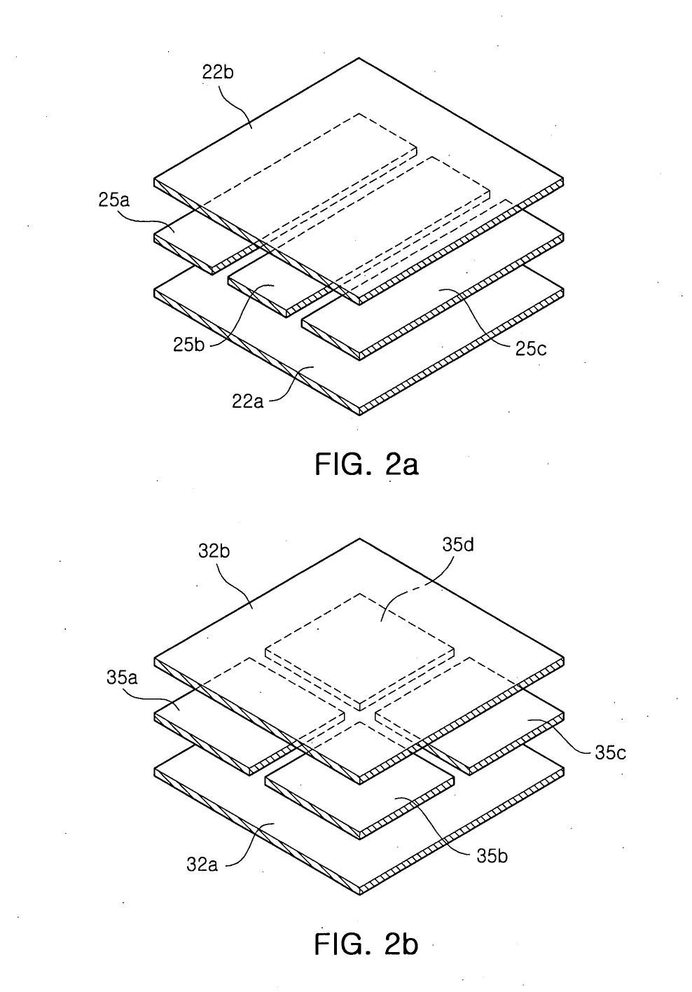

FIGS. 2A and 2B illustrate a floating electrode configured as divided electrode elements according to an exemplary embodiment of the invention. FIGS. 2A and 2B illustrate an arrangement of only first and second electrodes and the floating electrode, omitting dielectric layers, for explanatory sake. However the dielectric layers are construed to be disposed between the first electrode and the floating electrode and between the second electrodes and the floating electrode.

First, FIG. 2A illustrates an electrode arrangement including the first and second electrodes 22a and 22b, three floating electrode patterns 25a, 25b and 25c interposed therebetween. As described above, this electrode arrangement is construed as a capacitor structure where a dielectric material is filled between the first electrode 22a and the first to third floating electrode patterns 25a to 25c and between the second electrode 22b and the first to third floating electrode patterns 25a to 25c.

In this electrode arrangement, similarly to the capacitor 10 described in FIG. 1, the first and second electrodes 22a and 22b are connected to first and second polarities of a certain supply voltage, respectively. However, the first to third floating electrode patterns 25a to 25c are not directly connected to the supply voltage and not in direct contact with the first and second electrodes 22a and 22b.

According to the present embodiment, the floating electrode is divided in one direction and configured as the three equally-sized floating electrode patterns 25a to 25c. The first to third floating electrode patterns 25a to 25c are understood to define a an equivalent circuit where a pair of pseudo capacitance elements formed by the first and second electrodes 22a and 22b are connected in series together and connected in parallel with an existing capacitance element.

Also, the first to third floating electrode patterns 25a to 25c may be disposed coplanarly. This assures simpler designing of the first to third floating electrode patterns 25a to 25c compared to a case where the first to third floating patterns 25a to 25c are disposed on a different plane, thereby simplifying a process. For example, when the present embodiment employs a thin film capacitor embedded in a multi-layer wiring board, the floating electrode patterns 25a to 25c shown in FIG. 2A may be obtained by forming a lower dielectric layer, forming an electrode layer for the floating electrode, and then patterning the electrode layer by a known process.

Meanwhile, as described above, to attain higher capacitance, the dielectric layers between the first and second electrodes 22a and 22b may be identical in thickness to each other.

FIG. 2B illustrates an electrode arrangement similar to that of FIG. 2A. Here the only difference is that a floating electrode disposed between first and second electrodes 32a and 32b are divided into a 2×2 matrix and configured as four floating electrode patterns 35a, 35b, 35c and 35d. As just described, the floating electrode of the present embodiment is divided into a 2×2 matrix to form the equally-sized first to fourth floating electrode patterns 35a to 35d.

Of course, in a similar manner to the aforesaid embodiment, the first and second electrodes 32a and 32b are connected to first and second polarities of a certain supply voltage, respectively, but not directly connected to the supply voltage and not in direct contact with the first and second electrodes 32a and 32b.

Moreover, the first to fourth floating electrode patterns 35a, 35b, 35c and 35d may be disposed coplanarly to ensure a simpler process and easier designing of capacitance. In addition, dielectric layers (not shown) disposed between the first electrode 32a and the floating electrode and between the second electrode 32b and the floating electrode may be designed to an identical thickness, thereby resulting in higher capacitance.

As described above, the floating electrode may be formed into various patterns. In the aforesaid embodiment, the floating electrode patterns are equally sized, but not limited thereto. At least some of the floating electrode patterns may be different in size.

The capacitor of the present embodiment may be embedded in a multi-layer wiring board to offer better advantages. Particularly, the capacitor of the present embodiment can assure high capacitance without much increase in its volume and also does not necessitate an additional interlayer circuit structure, thereby beneficially used as the embedded capacitor of the multi-layer wiring board.

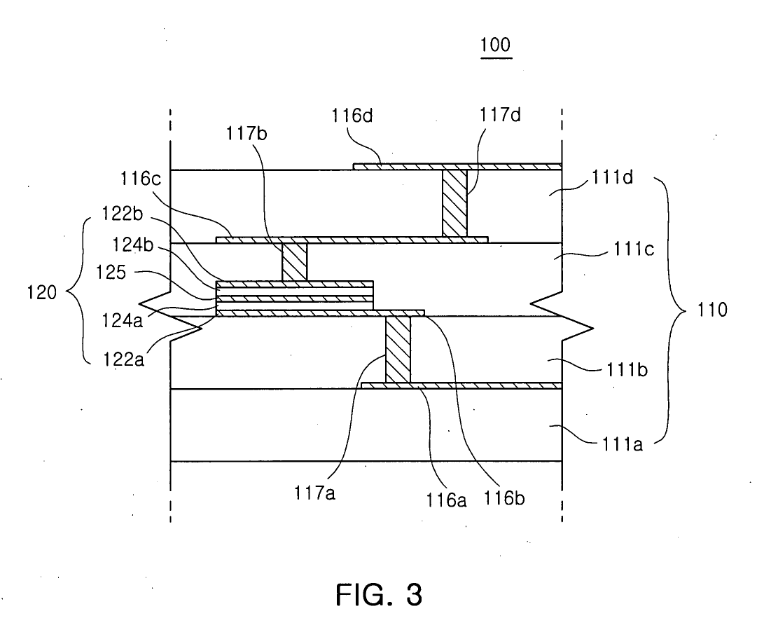

FIG. 3 is a cross-sectional view illustrating a capacitor-embedded LTCC board according to an exemplary embodiment of the invention.

Referring to FIG. 3, the LTCC board 100 includes an insulating body 111 formed of a plurality of ceramic layers 111a to 111d, i.e., insulating layers. Each of the first to fourth ceramic layers 111a to 111d is provided with at least one of a conductive line 116a to 116d and a conductive via 117a to 117d, thereby constituting a desired interlayer circuit.

According to the present embodiment, an embedded capacitor 120 includes a first electrode layer 122a, a first dielectric layer 124a, a floating electrode 125, a second dielectric layer 124b and a second electrode layer 122b sequentially deposited on the second ceramic layer 111b.

Here, the first and second electrode layers 122a and 122b are connected to the interlayer circuit. The first electrode layer 122a is connected to the conductive line 116b formed on the second ceramic layer 111b and the second electrode layer 122b is connected to the conductive via 117b extending through the third ceramic layer 111c and connected to the conductive line 116c formed on the fourth ceramic layer 111d. Meanwhile, the floating electrode 125 is disposed between the first and second dielectric layers 124a and 124b and not directly connected to the interlayer circuit.

As described above, the embedded capacitor 120 of the present embodiment may have an additional capacitance element generated by the floating electrode 125, other than capacitance generated by a capacitor having the first and second electrode layers 122a and 122b connected to the interlayer circuit and the first and second dielectric layers 124 and 124b disposed therebetween. More specifically, the embedded capacitor 120 is understood to have a capacitance element defined by the floating electrode 125—the first dielectric layer 124a—the first electrode 122a and a capacitance element defined by the floating electrode 125—the second dielectric layer 124b—the second electrode 122b connected in series with each other.

Therefore, the embedded capacitor of the present embodiment allows higher capacitance which is hardly expected from a conventional capacitor with a similar volume, and reduces loss from leakage current by the floating electrode 125.

Particularly, notwithstanding higher capacitance and improved capacitor characteristics, the embedded capacitor 120 does not necessitate an additional interlayer circuit, thus eliminating a problem of complicating a circuit of the multi-layer wiring board or obviating a need for changing the design of the conventional interlayer circuit considerably.

The capacitor of the present embodiment may be easily applicable to a variety of multi-layer wiring boards other than the LTCC board.

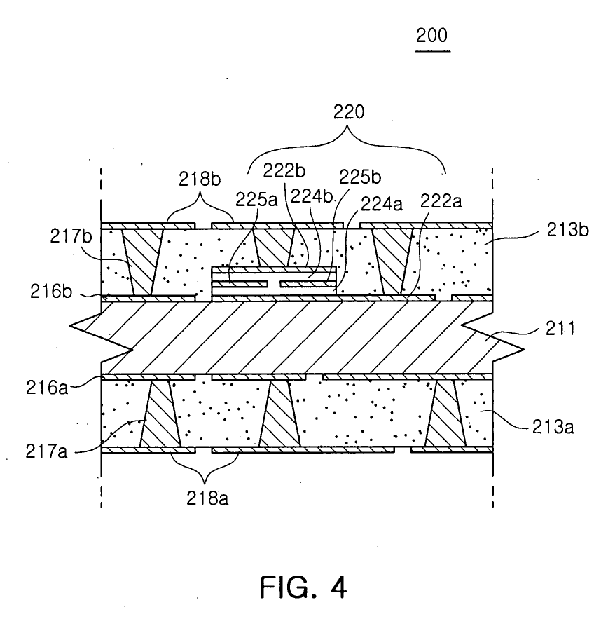

FIG. 4 is a cross-sectional view illustrating a capacitor-embedded printed circuit board according to an exemplary embodiment of the invention.

Referring to FIG. 4, the printed circuit board 200 includes an insulating polymer core layer 211 having metal patterns 216a and 216b formed on top and bottom thereof, and first and second insulating layers 213a and 213b formed on the top and bottom of the core layer 211, respectively. The core layer 211 and the first and second insulating layers 213a and 213b constitute an insulating body of the printed circuit board 200. The metal patterns 216a and 216b of the core layer 211 may be obtained by patterning a copper foil (not shown) previously provided on the top and bottom of the core layer 211.

Each of the first and second insulating layers 213a and 213b is provided with at least one of a conductive line 218a and 218b and a conductive via 217a and 217b, thereby forming a desired interlayer circuit.

As in the present embodiment, in the embedded capacitor 220, the metal pattern formed by patterning the copper foil on the top of the core layer may provide a lower electrode layer 222a. The lower electrode layer 222a constitutes the embedded capacitor 220 together with a first dielectric layer 224a, floating electrodes 225a and 225b, a second dielectric layer 224b and a second electrode layer 222b.

As in the present embodiment, the embedded capacitor 220 may employ the floating electrode configured as two floating patterns 225a and 225b. The first and second floating electrode patterns 225a and 225b are disposed between the first and second dielectric layers 224a and 224b and not directly connected to the interlayer circuit.

Also, the first and second electrode layers 222a and 222b are connected to the interlayer circuit. That is, the first and second electrode layers 22a and 222b may be connected to the conductive vias formed on the second insulating layer 213b, respectively.

In this fashion, the embedded capacitor 220 of the present embodiment may have an additional capacitance element generated by the floating electrode 225, other than capacitance generated by a capacitor having the first and second electrode layers 222a and 222b connected to the interlayer circuit and the first and second dielectric layers 224 and 224b disposed therebetween. Therefore, the embedded capacitor 220 of the present embodiment achieves high capacitance which is hardly expected from the conventional capacitor with a similar volume. Moreover, the embedded capacitor 220 of the present embodiment may be reduced in loss from leakage current by the floating electrode 225.

The embedded capacitor 220 with these advantages may be beneficially applicable to the printed circuit board as described in the present embodiment without requiring the additional interlayer circuit.

To confirm improved effects from the capacitor structure of the present embodiment, a capacitor having a floating electrode similar to that of FIG. 1 and a conventional MIM capacitor were manufactured to evaluate capacitor characteristics.

### INVENTIVE EXAMPLE

According to Inventive Example, a thin film capacitor structured as in FIG. 1 was manufactured.

First, a dielectric thin film was formed to a thickness of 200 nm on a plated copper foil deposited plate having defect-free surfaces, and a floating electrode was deposited to a thickness of 50 nm. Subsequently, a dielectric thin film was deposited to a thickness of 200 nm and then an upper electrode was formed.

### COMPARATIVE EXAMPLE

According to Comparative Example, a thin film MIM capacitor was manufactured under the same conditions as those of the aforesaid Inventive Example except that a floating electrode was not formed. That is, a dielectric thin film was formed to a thickness of 400 nm on the identical copper foil deposited plate and in an identical chamber, and an upper electrode was formed.

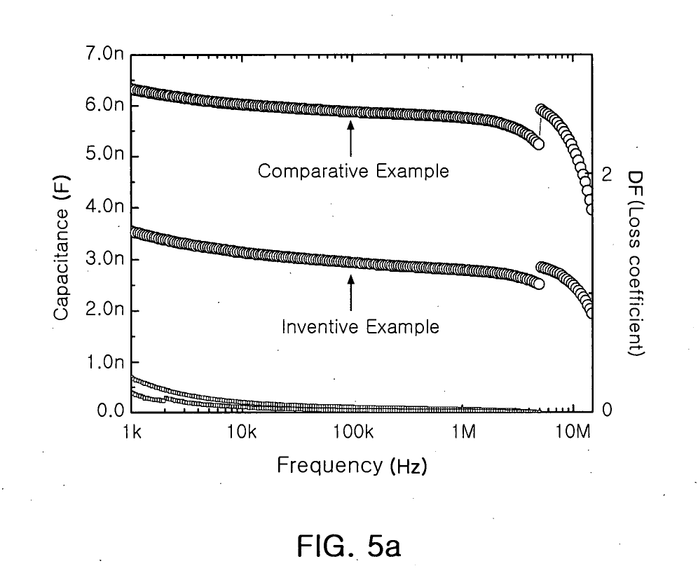

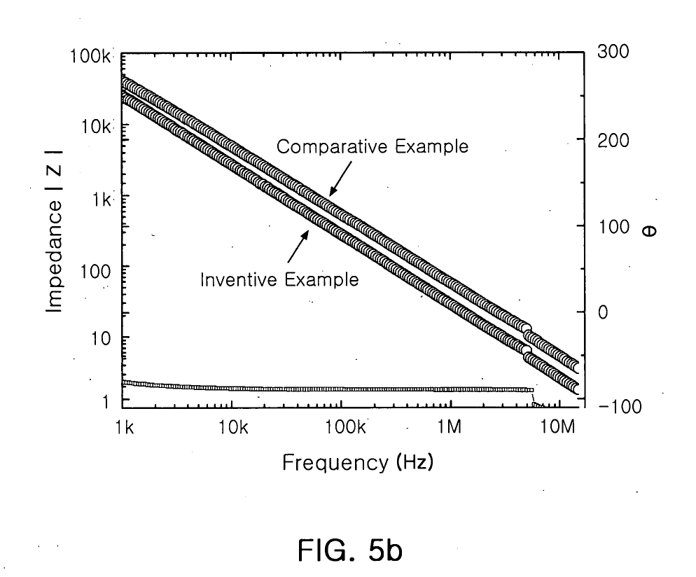

Characteristics of the capacitors manufactured according to Inventive Example and Comparative Example were evaluated. FIGS. 5A and 5B are graphs illustrating the results.

Referring to FIG. 5A, the capacitor of Inventive Example was almost doubled in capacitance compared to the capacitor of Comparative Example. Also, the capacitor of Inventive Example demonstrated little difference from the capacitor of Comparative Example in terms of loss value DF. The capacitor of Inventive Example showed a moderate decrease in loss value according to increase in frequency. Moreover the capacitor of Inventive Example was significantly improved in loss characteristics compared to a case where the dielectric thin film was reduced in thickness (for example, 200 nm as in the Comparative Example) to obtain equal capacitance. Meanwhile, as shown in FIG. 5B, the capacitor of Inventive Example exhibited a moderate decrease in impedance according to increase in capacitance compared to the capacitor of Comparative Example.

As set forth above, according to exemplary embodiments of the invention, a capacitor is minimized in rapid deterioration of loss characteristics caused by reduction in a gap between electrodes, i.e., thickness of a dielectric thin film and allows higher capacitance. Especially, even when the capacitor is embedded in a multi-layer wiring board such as a printed circuit board, only a floating electrode may be formed through a layer growth process employed in manufacturing of the capacitor, without entailing complicated modification or addition of an interlayer circuit, thereby advantageously producing a high-capacitance capacitor.

While the present invention has been shown and described in connection with the exemplary embodiments, it will be apparent to those skilled in the art that modifications and variations can be made without departing from the spirit and scope of the invention as defined by the appended claims.

What is claimed is:

1. A capacitor comprising:
first and second electrodes connected to first and second polarities, respectively;
a dielectric layer formed between the first and second electrodes; and
at least one floating electrode having overlaps with the first and second electrodes to form a capacitance in each of the overlaps, the floating electrode disposed inside the dielectric layer.

2. The capacitor of claim 1, wherein the floating electrode is disposed in parallel with the first and second electrodes.

3. The capacitor of claim 1, wherein the floating electrode comprises a plurality of floating electrodes disposed coplanarly and spaced apart from one another.

4. The capacitor of claim 1, wherein the floating electrode is spaced apart from the first electrode and the second electrode at a substantially identical distance, respectively.

5. A capacitor-embedded multi-layer wiring board comprising:
an insulating body having a plurality of insulating layers deposited thereon;
a plurality of conductive patterns and conductive vias formed on the insulating layers, respectively, to constitute an interlayer circuit of the insulating body; and
a thin film capacitor embedded in the insulating body,
wherein the thin film capacitor comprises a first electrode layer, a first dielectric layer, at least one floating electrode layer, a second dielectric layer and a second electrode layer sequentially formed, and
wherein the first and second electrode layers are connected to the interlayer circuit and the floating electrode layer is not directly connected to the interlayer circuit and has overlaps with the first and second electrode layers to form a capacitance in each of the overlaps.

6. The capacitor-embedded multi-layer wiring board of claim 5, wherein the floating electrode layer is disposed in parallel with the first electrode layer and the second electrode layer, respectively.

7. The capacitor-embedded multi-layer wiring board of claim 5, wherein the floating electrode comprises a plurality of floating electrode layers disposed coplanarly and spaced apart from one another.

8. The capacitor-embedded multi-layer wiring board of claim 5, wherein the first and second dielectric layers have an identical thickness.

9. The capacitor-embedded multi-layer wiring board of claim 5, wherein the insulating layer is a fired ceramic layer and the multi-layer wiring board is a multi-layer ceramic board.

10. The capacitor-embedded multi-layer wiring board of claim 6, wherein the insulating layer is a fired ceramic layer and the multi-layer wiring board is a multi-layer ceramic board.

11. The capacitor-embedded multi-layer wiring board of claim 7, wherein the insulating layer is a fired ceramic layer and the multi-layer wiring board is a multi-layer ceramic board.

12. The capacitor-embedded multi-layer wiring board of claim 8, wherein the insulating layer is a fired ceramic layer and the multi-layer wiring board is a multi-layer ceramic board.

13. The capacitor-embedded multi-layer wiring board of claim 5, wherein the insulating layer contains polymer and the multi-layer wiring board is a printed circuit board.

14. The capacitor-embedded multi-layer wiring board of claim 6, wherein the insulating layer contains polymer and the multi-layer wiring board is a printed circuit board.

15. The capacitor-embedded multi-layer wiring board of claim 7, wherein the insulating layer contains polymer and the multi-layer wiring board is a printed circuit board.

16. The capacitor-embedded multi-layer wiring board of claim 8, wherein the insulating layer contains polymer and the multi-layer wiring board is a printed circuit board.
